(19) United States
(12) Patent Application Publication
(10) Pub. No.: US 2005/0251791 A1
(43) Pub. Date: Nov. 10, 2005

(54) Systems and methods for branch profiling loops of an executable program

(76) Inventor: Robert Hundt, Santa Clara, CA (US)

Correspondence Address: HEWLETT-PACKARD COMPANY;Intellectual Property Administration, P.O. BOX 272400, Fort Collins, CO, 80527-2400, US

(21) Appl. No.: 11/089,585

(22) Filed: Apr. 14, 2004

(51) Int. Cl. G06F 9/44

(52) U.S. Cl. 717/130

(57) ABSTRACT

Systems and methods for branch profiling an executable program are disclosed. One embodiment relates to a method of branch profiling an executable program. The method may comprise inserting an integer add instruction in branches of a loop of the executable program, inserting path counter instructions after a last branch of the loop and prior to an exit point of the loop, and inserting loop counter array update instructions after the exit point of the loop.

### CROSS REFERENCE TO RELATED APPLICATIONS

This application is related to the following commonly assigned co-pending patent application entitled: “SYSTEMS AND METHODS FOR INSTRUMENTING LOOPS OF AN EXECUTABLE PROGRAM,” Attorney Docket No. 200313028-1, which is filed contemporaneously herewith and is incorporated herein by reference.

### BACKGROUND

Code instrumentation is a method for analyzing and evaluating program code performance. Source instrumentation modifies a program's original source code, while binary instrumentation modifies an existing binary executable. In one approach to binary code instrumentation, new instructions or probe code are added to an executable program, and consequently, the original code in the program is changed and/or relocated. Some examples of probe code include adding values to a register, moving the address of some data to some registers, and adding counters to determine how many times a function is called. The changed and/or relocated code is referred to as instrumented code, or more generally, as an instrumented process.

One specific type of code instrumentation is referred to as dynamic binary instrumentation. Dynamic binary instrumentation allows program instructions to be changed on-the-fly. Measurements such as basic-block coverage and function invocation counting can be accurately determined using dynamic binary instrumentation. Additionally, dynamic binary instrumentation, in contrast to static instrumentation, is performed at run-time of a program and only instruments those parts of an executable that are actually executed. This minimizes the overhead imposed by the instrumentation process itself. Furthermore, performance analysis tools based on dynamic binary instrumentation require no special preparation of an executable such as, for example, a modified build or link process.

### SUMMARY

One embodiment of the present invention may comprise a system for branch profiling an executable program. The system may comprise a branch profiler that assigns branch integers to branches in a loop and a plurality of path values that correspond to sums of the branch integers through respective execution paths in the loop. The system may also comprise a probe instrument that inserts an integer add instruction into branches of the loop, a set of path counter instructions after a last branch in the loop, and a set of loop path counter array update instructions after an exit point of the loop.

Another embodiment may comprise a method of branch profiling of an executable program. The method may comprise inserting an integer add instruction in branches of a loop of the executable program, inserting path counter instructions after a last branch of the loop and prior to an exit point of the loop, and inserting loop counter array update instructions after the exit point of the loop.

Another embodiment relates to a computer readable medium having computer executable instruction for performing a method. The method may comprise performing a branch profiling on at least one loop in an executable program to assign branch integers to branches and path values to execution paths in the at least one loop, inserting integer add instructions to branches of the at least one loop, inserting path counter instructions at an end of the at least one loop, and inserting loop path counter array update instructions after an exit point of the at least one loop.

Still another embodiment may relate to a dynamic instrumentation system. The dynamic instrumentation system may comprise means for generating an intermediate representation of a function associated with an executable program, means for analyzing the intermediate representation to identify at least one loop in the function, and means for performing branch profiling on the identified at least one loop to assign branch integers to branches and path values to execution paths of the identified at least one loop. The system may further comprise means for inserting code into the identified at least one loop. The means for inserting code may insert integer add instructions into branches of the identified at least one loop, and path counter instructions at an end of the identified at least one loop. The system may also comprise means for encoding the inserted code and the intermediate representation of the function to produce an instrumented function.

### BRIEF DESCRIPTION OF THE DRAWINGS

FIG. 1 illustrates an embodiment of a dynamic instrumentation system.

FIG. 2 illustrates an embodiment of components associated with a dynamic instrumentation tool.

FIG. 3 illustrates an embodiment of a block diagram of contents of a portion of shared memory.

FIG. 4 illustrates an embodiment of a loop associated with an executable program having instrumentation counters inserted therein.

FIG. 5 illustrates an embodiment of a loop counter array update routine associated with a loop of an executable program.

FIG. 6 illustrates another embodiment of a loop counter array update routine associated with a loop of an executable program.

FIG. 7 illustrates a methodology for inserting instrumentation code into an executable program.

FIG. 8 illustrates an embodiment of an alternate methodology for inserting instrumentation code in an executable program.

FIG. 9 illustrates an embodiment of yet another alternate methodology for inserting instrumentation code in an executable program.

FIG. 10 illustrates an embodiment of a computer system.

### DETAILED DESCRIPTION

This disclosure relates generally to dynamic instrumentation systems and methods. Branch profiling is performed on at least one loop of an executable program. The branch profiling determines the possible paths through branches of the at least one loop. The branch profiling then assigns branch integers to branches contained within the at least one loop, and a plurality of path values for respective possible execution paths through the branches. The path values correspond to the sum of the branch integers over a respective path. Integer add instructions are inserted in respective branches. The integer add instructions sum up the branch integers of a given execution path for a given loop execution. Path counter instructions are inserted at an end of the at least one loop. Upon completion of a loop iteration, program execution is directed to the path counter instructions. The path counter instructions compare the value of an integer adder with the plurality of path values to determine which path of the plurality of execution paths has been taken during the given single loop execution. A corresponding path counter associated with the execution path that has been taken is incremented for a respective loop iteration.

A loop path counter array update instruction is inserted after an exit point of the loop. The loop path counter array update instruction updates loop path counter entries in a loop path counter array with the number of executions for respective paths taken through the loop. One or more loops can be assigned loop path counter arrays. The loop path counter array update instructions can be embedded in a multi-thread safe set of ownership instructions, such as a spinlock operation. A spinlock operation provides a thread with ownership of the loop path counter array entries stored in memory, preventing other threads from modifying the loop path counter entries associated with the loop path counter array, until the ownership is released.

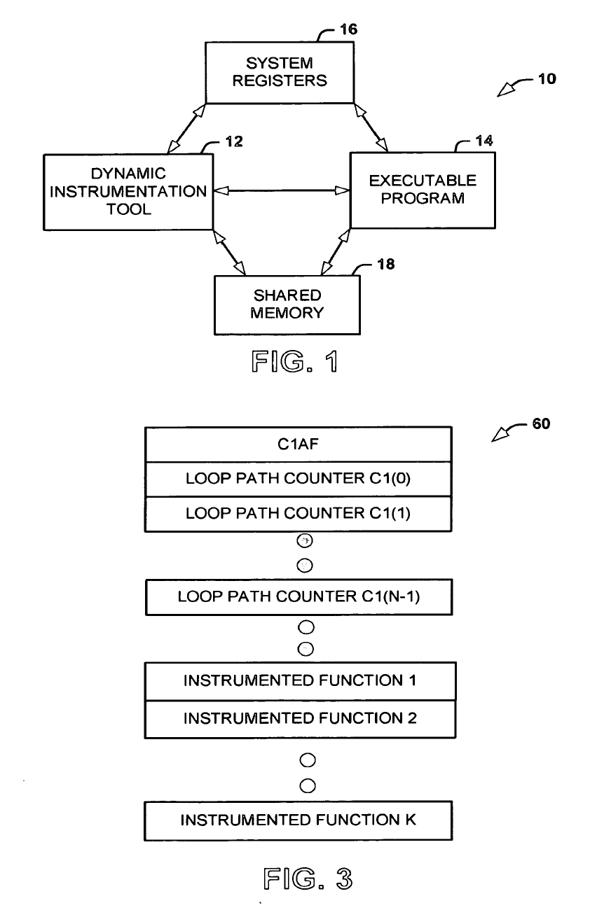

FIG. 1 illustrates a dynamic instrumentation system 10. The dynamic instrumentation system 10 can be a computer, a server or some other computer medium that can execute computer readable instructions. For example, the components of the system 10 can be computer executable components running on a computer, such as can be stored in a desired storage medium (e.g., random access memory, a hard disk drive, CD ROM, and the like). The dynamic instrumentation system 10 includes a dynamic instrumentation tool 12. The dynamic instrumentation tool 12 interfaces with an executable program 14 to assign instrumentation (e.g., counters) to the executable program 14.

The dynamic instrumentation tool 12 is operative to perform branch profiling on the executable program 14. The branch profiling includes analyzing at least one loop to assign integer values to branches within the at least one loop, and path values that correspond to unique execution paths through the at least one loop. The sum of the branch integers through an execution path is equal to a respective path value, such that an execution path through the at least one loop can be determined by decoding the path value. The branch profiling can be an algorithm (e.g., Ball-Larus algorithm) for assigning integers to branches and path values to unique execution paths.

The dynamic instrumentation tool 12 is operative to assign instrumentation counters to at least one loop associated with the executable program 14. The instrumentation counters can include an integer adder that adds branch integers associated with branch executions to provide a unique path value for a given loop execution. The instrumentation counters can include path counters that maintain a count associated with a number of times a given execution path has been taken over the total loop iterations of a respective loop. The dynamic instrumentation tool 12 is operative to assign a free register to the at least one loop for integer adding, and a plurality of free registers for path counting.

A free register can be found by analyzing the executable program 14 to determine which registers are used for storing data by the executable program and which registers are not used. Additionally, the code can be analyzed to determine which registers are currently available for use that would not interfere with the executable program execution. It is to be appreciated that a variety of techniques can be employed to find a free register.

The dynamic instrumentation tool 12 can load the executable program 14 and insert breaks at a beginning of each function under the control of a debugging interface, which is provided by the operating system (e.g., ttrace( ) on HP-UX® Operating System, ptrace( )on LINUX® Operating System, Extended Debugging Interface (eXDI) on MICROSOFT WINDOWS® Operating System). The executable program 14 then is executed. The debugging interface makes it possible to transfer control from the target application to the dynamic instrumentation tool 12 whenever a break is encountered in the executable program.

As the executable program 14 encounters the breaks corresponding to a new reached function, control is passed to the dynamic instrumentation tool 12. The dynamic instrumentation tool 12 loads the function. The dynamic instrumentation tool 12 then converts the function into an intermediate representation by decoding the binary code associated with the function and converting the decoded binary code via an intermediate representation instrument. A control flow graph constructor then generates a control flow graph from the intermediate representation. A loop analysis is then performed on the intermediate representation by a loop recognition algorithm.

Branch profiling can be performed on the control flow graph to identify branches and possible execution paths through the one or more loops. A branch profiling algorithm (e.g., Ball-Larus algorithm) can be employed to assign branch integers to branches and path values to execution paths through one or more loops, such that the branch integers can be summed to determine an execution path that has been taken through a given loop during a single loop execution. The branch integer sum is a unique value that corresponds to a specific execution path through a set of branches.

The dynamic instrumentation tool 12 can then insert one or more instrumentation counters via a probe code instrumenter. The one or more instrumentation counters include an integer adder that adds a branch integer corresponding to an executed branch to the integer adder. The integer adder can be a free register. The probe instrument can insert instructions in branches to increment the free register by the value of the branch integer when the branch is executed. At the end of the loop, the free register will provide a path value associated with execution through a set of branches corresponding to the execution path through the loop.

A path counter can be employed for each unique path through a loop iteration. A respective path counter can be incremented each time its corresponding execution path is taken by comparing the sum of the integer adder with a set of assigned path values that identify which execution path has been taken. A path counter can include a free register that is incremented if its associated path has been taken. The probe instrument can insert instructions that increment a respective path counter if the integer adder value is equal to the path value associated with the respective path counter. In this manner, a respective path counter is incremented through each loop iteration based on the execution path through the loop. Once execution of the loop has completed (e.g., after a plurality of loop iterations), the path counters will contain values indicative of the number of times a particular path through the loop has been taken for each possible execution path.

As previously stated, a number of different techniques can be employed to generate free registers. Free registers are inherently multi-thread safe. Typically, loop counters are employed to count loop iterations by utilizing atomic memory update instructions. The atomic memory update instructions are multi-thread safe, but are substantially time intensive (e.g., about 20 clock cycles) as compared to a register add instruction (e.g., about 1 clock cycle).

A loop path counter array update instruction is inserted after an exit point of the loop. The loop path counter array update instructions updates loop path counter entries in a loop path counter array with the number of executions for the paths taken through a respective loop associated with the executable program. The loop path counter array update instructions can be embedded in a multi-thread safe set of ownership instructions, such as a spinlock operation. A spinlock operation provides a thread with ownership of the loop path counter array stored in memory preventing other threads from modifying the loop path counter array, until the ownership is released. The loop path counter array maintains a count associated with total path executions of each possible execution path over one or more loop executions associated with a given loop. A respective loop path counter array can be assigned to respective loops for one or more loops in the executable program 14.

The dynamic instrumentation tool 12 then encodes the modified function code to provide an instrumented function in binary form. The instrumented function is stored in a shared memory 18. The original entry point of the function (where the break point was placed) is patched with a branch/jump to the instrumented version of the function. Execution is then resumed at the address of the instrumented function (e.g., resume can be an option in the debug interface). Therefore, control has been transferred back to the executable program, which continues to execute until another breakpoint at a new non-encountered function is encountered. The process then repeats for the next function until all function have been instrumented. Once the executable program 14 and instrumented functions have completed execution, the dynamic instrumentation tool 12 can retrieve the loop path counter entries from one or more loop path counter arrays from the shared memory 18.

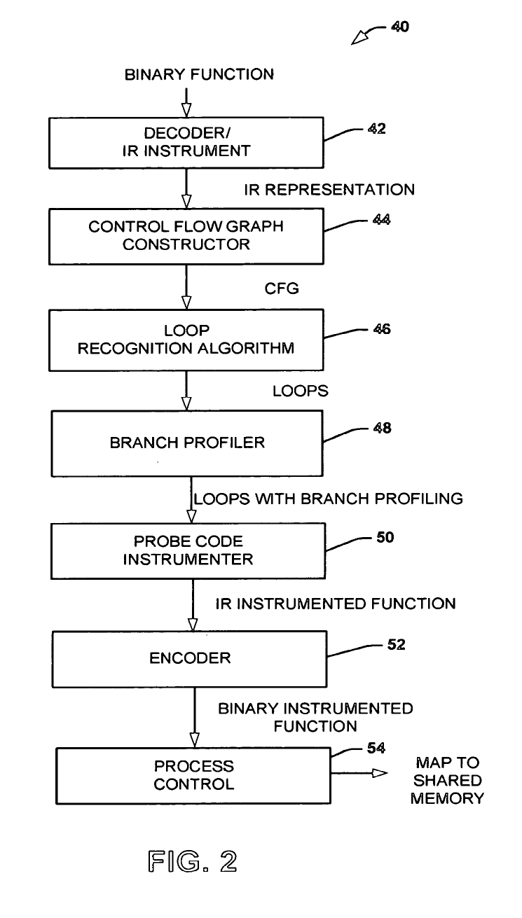

FIG. 2 illustrated components associated with a dynamic instrumentation tool 40. The dynamic instrumentation tool 40 includes a decoder and an intermediate representation (IR) instrument 42 that reads in the binary function, and decodes the binary function into an intermediate representation. A control flow graph constructor 44 can configure the intermediate representation as a control flow graph with basic blocks and edges between those blocks representing possible flows of control. A loop analysis can be performed on the loop by a loop recognition algorithm 46. The loop recognition algorithm 46 can be one of many different algorithms known for recognizing loops in a control flow graph.

The dynamic instrumentation tool 40 includes a branch profiler 48. The branch profiler 48 analyzes the branches in one or more loops to identify potential execution paths through the one or more loops. Each branch is assigned a branch integer and each execution path is assigned a path value, such that the sum of branch integers through each possible execution path of a set of branches provides a unique path value. In this manner, the particular execution path taken through the branches can be determined in which paths can be reconstructed by comparing the integer sum values with the different path values.

The dynamic instrumentation tool 40 also includes a probe code instrumenter 50. The probe code instrumenter 50 can insert integer add instructions in the branches. The integer add instructions can add the corresponding branch integer to an integer adder for an executed branch. The probe code instrumenter 50 can insert path counter instructions that can increment respective path counters that maintain a path count for a respective execution path. The path counter instructions can be inserted at the end of a loop prior to an exit point of the loop. The probe code instrumenter 50 can insert loop path counter array update instructions after the exit point of a loop. The loop path counter array update instruction updates loop path counter entries of the loop path counter array to maintain path execution counts over one or more executions of a given loop. A plurality of loops can be assigned respective loop path counter arrays.

Free registers can be employed to implement the integer adder and the path counters. The probe code instrumenter 50 can insert register initialization instruction at the loop entry point. The probe code instrumenter 50 can generate free registers associated with the integer add instructions and the path counter instructions for one or more loops, as long as free registers are available. If free register are no longer available, the probe code instrumenter 50 can insert path counter instructions that store the path count values to memory. The dynamic instrumentation tool 40 includes an encoder 50 that encodes the IR instrumented function into a binary instrumented function. The dynamic instrumentation tool 40 includes a process control 52 that stores the binary instrumented function in shared memory, patches a branch/jump instruction in the executable program where the break point was placed, and passes control back to the executable program.

FIG. 3 illustrates a block diagram of contents of a portion of shared memory 60 associated with branch profiling an executable program. The shared memory 60 retains a loop path counter array (C1) having a plurality of loop path counter entries (C1(0)-C1(N-1)). The loop path counter array maintains an updated counter for each execution path via a respective loop path counter entry for a given loop. The loop path counter array is labeled 0 to N-1, where N is an integer equal to the number of execution paths in the loop. In one embodiment, path values can be assigned to execution paths from 0 to N-1, such that the path value can be employed to readily update a corresponding loop path counter entry (e.g., C1(PV₀), C1(PV₁), . . . , C1(PV_{N-1})). The loop path counter entries correspond to the number of executed path iterations of each executed path in a given loop. The loop path counter array is updated each time the given loop completes execution in the executable program and a loop exit point is encountered. A respective loop path counter entry of the loop path counter array is updated by adding the current value of the loop path counter entry with the value of the path counter associated with the respective execution path. Since the loop path counter array resides in shared memory 60, the loop path counter entries are not multi-thread safe.

Therefore, the shared memory 60 includes a loop path counter array access flag, labeled C1AF, associated with the loop path counter array. The access flag is employed to maintain ownership of the loop path counter array memory spaces by a single process at a time, so that loop path counter array integrity is maintained. For example, if a process desires to overwrite the loop path counter array, the process will request control of the loop path counter array by checking the corresponding counter access flag. If the counter access flag is not set, the process will set the flag and update the corresponding loop path counter array. The process will then reset the flag and release control of the loop path counter array, so that other processes may access the loop path counter array in shared memory 60. In this manner, loop path counter array integrity is maintained by being multi-thread safe. It is to be appreciated that a respective loop path counter array can be assigned to a respective loop for one or more loops in an executable program to maintain path counts for the one or more loops.

The shared memory 60 also retains a plurality of instrumented functions, labeled 1 through K, where K is an integer greater than or equal to one. The dynamic instrumentation tool stores the encoded instrumented functions in shared memory 60 to provide ready access to both the instrumentation tool and the executable program. The address associated with a given instrumented function is placed before the associated function in the executable program, such that the instrumented function is executed in place of the given function via a jump or call instruction. Once the executable program is completely instrumented, a substantial portion of executable program execution occurs in shared memory 60 via the instrumented functions.

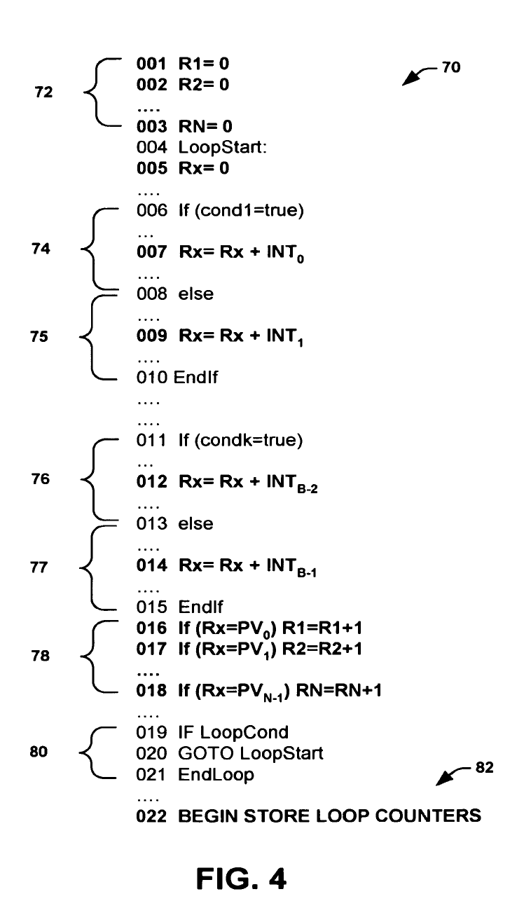

FIG. 4 illustrates a loop 70 associated with an executable program having instrumentation counters inserted therein. The loop 70 can reside in a function in the executable program. The loop 70 can be an innermost loop, an outermost loop or an intermediary loop. The innermost loops of the executable program are loops that contain no inner loops, while the outermost loops are not nested in any outer loop. Intermediate loops are loops that are both inner loops and outer loops, such that the intermediate loop is a loop that is nested in one or more outer loops and also contain one or more inner loops nested therein. The instrumentation execution speed can be improved by generating free registers for innermost loops first, intermediate loops second, and outermost loops last, as long as free registers are available.

The loop 70 includes instrumentation code provided by a dynamic instrumentation tool. The dynamic instrumentation tool assigns a set of free registers to the loop 70. A first register Rx is employed as an integer adder, while the remaining registers R1-RN are employed as path counters. The dynamic instrumentation tool inserts a set of register initialization instructions 72 (R1=0; R2=0; . . . ;RN=0) at lines 001-003 prior to a loop start or entry point (004) to reset the path counters. The dynamic instrumentation tool inserts an integer adder register initialization instruction (Rx=0) at lines 005 after a loop start or entry point (004) to reset the integer adder for each loop iteration.

The dynamic instrumentation tool inserts a register integer add instruction in one or more control flow branches of the loop 70. For example, a first register integer add instruction (Rx=Rx+INT₀) is inserted at line 007 within a first branch 74 indicated as extending from lines 006 to 008, and a second register integer add instruction (Rx=Rx+INT₁) is inserted at line 009 within a second branch 75 indicated as extending from lines 008 to 010. If cond1 is true at line 006, the first branch 74 will be executed and the integer adder (Rx) will be incremented by INT₀. If cond1 is false at line 006, the second branch 75 will be executed and the integer adder (Rx) will be incremented by INT₁.

The process is repeated for B number of branches. For example, a B-2 integer add instruction (Rx=Rx+INT_{B-2}) is inserted at line 012 within a B-2 branch 76 indicated as extending from lines 011 to 013, and a B-1 integer add instruction (Rx=Rx+INT_{B-1}) is inserted at line 014 within a B-1 branch 77 indicated as extending from lines 013 to 015. If condk is true at line 011, the B-2 branch 76 will be executed and the integer adder (Rx) will be incremented by INT_{B-2}. If condk is false at line 011, the B-1 branch 77 will be executed and the integer adder (Rx) will be incremented by INT_{B-1}.

A set of path counter instructions 78 are inserted after the last branch 77 of the loop 70 and prior to an exit point 80 of the loop 70. The exit point 80 of the loop 70 includes a set of instructions illustrated in lines 019-021 in which a loop condition is determined from which the loop continues execution for another iteration if the loop condition is true and terminates loop execution if the loop condition is false. The set of path counter instructions 78 are illustrated in lines 016 to lines 018 in which the integer adder value is compared with a plurality of path values associated with a unique execution path that can be taken. For example, if the value of the integer adder (Rx) is equal to the path value PV₀, the value of a first path counter (R1) is incremented by one indicated that the execution path associated with the path value PV₀ has been executed. If the value of the integer adder (Rx) is equal to the path value PV₁, the value of a second path counter (R2) is incremented by one indicated that the execution path associated with the path value PV₁ has been executed. Finally, if the value of the integer adder (Rx) is equal to the path value PV_{N-1}, the value of a final path register RN is incremented by one indicated that the execution path associated with the path value PV_{N-1} has been executed, such that there are N possible unique execution paths.

The dynamic instrumentation tool also inserts a set of loop path counter array update instructions 82 after the exit point 80 of the loop 70 beginning at line 022. Execution of the loop path counter array update instructions 82 causes the loop path counter array entries in shared memory to be updated by adding the values of the path registers to the respective loop path counter entries of the loop path counter array in shared memory.

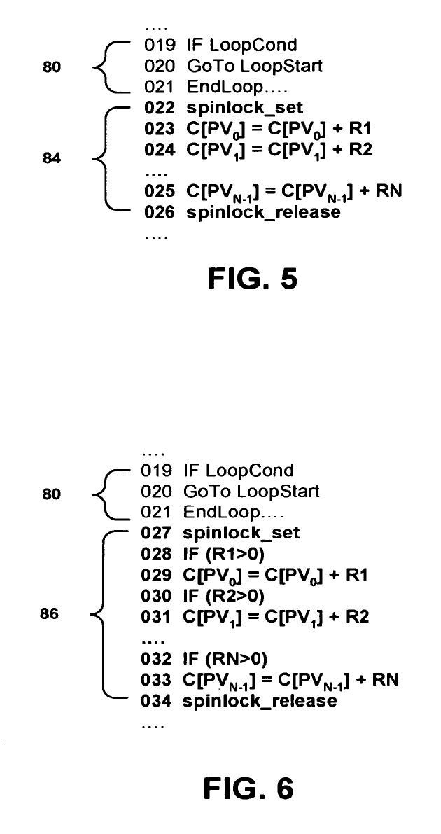

FIG. 5 illustrates a set of loop path counter array update instructions 84 as illustrated in lines 022-026. The set of loop path counter array update instructions 84 update a loop path counter array that includes loop path counter entries. The loop path counter entries retain loop path count values corresponding to the number of executed path iterations of a respective executed path in a given loop for one or more loop executions. The loop path counter array is updated each time the given loop terminates execution in the executable program and a loop exit point is encountered. A respective loop path counter entry of the loop path counter array is updated by adding the current value of the loop path counter entry with the value of the path counter associated with the respective execution path. For example, line 023 indicates that the loop path counter entry PV₀ is updated by the loop path counter R1 (C1[PV₀]=C1[PV₀]+R1), line 024 indicates that the loop path counter entry PV₁ is updated by the loop path counter R2 (C1[PV₁]=C1[PV₁]+R2), and line 025 indicates that the loop path counter entry PV_{N-1} is updated by the loop path counter RN (C1[PV_{N-1}]=C1[PV_{N-1}]+RN), such that each of the N loop path counter entries in the loop path counter array are updated.

Since the loop path counter array resides in shared memory, the loop path counter entries are not multi-thread safe. Therefore, the loop path counter array update instructions are embedded in memory ownership instructions, such that ownership of the loop path counter array memory locations are requested prior to updating of the loop path counter entries. For example, a spinlock access command is a set of instructions that requests access of a loop path counter array by checking the state of a loop access flag via a set of spinlock access instructions illustrated at line 022. The loop path counter entries are then updated by execution of the loop path counter update instructions 84. The loop access flag is then reset via set of spinlock release instructions illustrated at line 026, thus releasing ownership control of the memory locations associated with the loop path counter array. Although a single instruction is shown for illustrating a spinlock access instruction set, a loop path counter array update instruction and a spinlock release instruction set, a plurality of instructions can be employed to execute any of a spinlock access, a loop counter update and a spinlock release.

FIG. 6 illustrates another set of loop path counter array update instructions 86 illustrated in lines 027-034. The set of loop path counter array update instructions 86 includes instructions to determine if a respective register path counter has a non-zero value. The respective loop path counter entry is only updated if its associated register path counter has a non-zero value. In this manner, unnecessary writes to memory are avoided. For example, lines 028-029 indicate that the loop path counter entry PV₀ is updated by the loop path counter R1(C1[PV₀]=C1[PV₀]+R1) if R1 is greater than zero, lines 030-031 indicate that the loop path counter entry PV₁ is updated by the loop path counter R2 (C1[PV₁]=C1[PV₁]+R2) if R2 is greater than zero, and lines 032-033 indicate that the loop path counter entry PV_{N-1} is updated by the loop path counter RN (C1[PV_{N-1}]=C1[PV_{N-1}]+RN) if RN is greater than zero, such that only loop path counter entries in which execution paths have been taken are updated in the loop path counter array. The set of loop path counter array update instructions are embedded in memory ownership instructions including a spinlock instruction set illustrated at line 027, and a spinlock release instruction set illustrated in line 034.

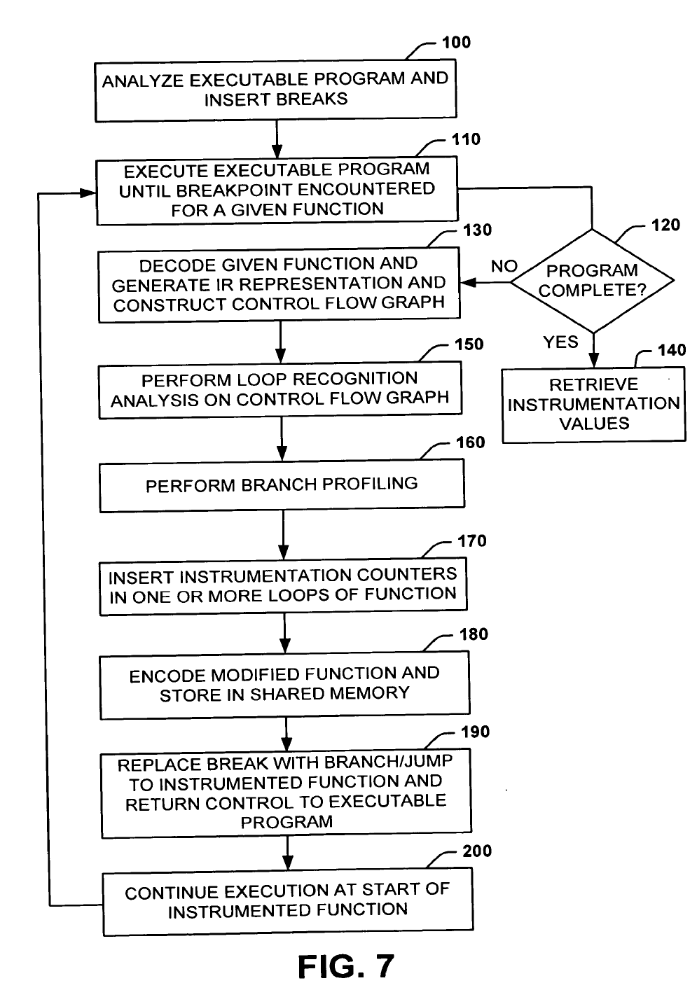

In view of the foregoing structural and functional features described above, certain methods will be better appreciated with reference to FIGS. 7-9. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., a computer or a computer network as one or more integrated circuits or circuit boards containing one or more microprocessors), software (e.g., as executable instructions running on one or more processors of a computer system), or any combination thereof.

FIG. 7 illustrates a methodology for branch profiling a loop of an executable program. The methodology begins at 100 where an executable program is analyzed and breaks are inserted before each function. The executable program then begins execution, until a breakpoint is encountered for a given function. Once a breakpoint is encountered, the methodology proceeds to 120. At 120, a determination is made as to whether the executable program has completed execution. If the executable program has completed execution (YES), the methodology proceeds to 140 to retrieve the instrumentation values. If the executable program has not completed execution (NO), the methodology proceeds to 130.

At 130, the dynamic instrumentation tool decodes the executable function and generates an intermediate representation of the given function, and generates a control flow graph from the intermediate representation. The dynamic instrumentation tool then performs loop recognition analysis on the control flow graph to identify loops in the given function at 150. After the loops have been identified, the methodology proceeds to 160.

At 160, branch profiling is performed on one or more loops. Branch profiling can be performed on the control flow graph to identify branches and possible execution paths through the one or more loops. A branch profiling algorithm (e.g., Ball-Larus algorithm) can be employed to assign branch integers to branches and path values to execution paths through one or more loops, such that the branch integers can be summed to determine an execution path that has been taken through a given loop during a single loop execution. The methodology then proceeds to 170.

At 170, one or more instrumentation counter instructions are inserted into one or more loops associated with the given function. The one or more instrumentation counter instructions include register initialization instructions, integer adder instructions, path counter instructions and loop path counter array update instructions for one or more respective loops. The instrumentation execution speed can be improved by generating free registers for implementing an integer adder and path counters for a given loop.

Register initialization instructions for initializing the path counters can be inserted prior to an entry point in the loop. A register initialization instruction for initializing the integer adder can be inserted after the entry point in the loop. The one or more inserted instructions include inserting integer adder instruction in branches that increment an integer adder free register by the value of the branch integer when the branch is executed. The one or more inserted instructions include inserting path counter instructions that increment respective path counter free registers by one if the integer adder value is equal to the path value associated with the respective path counter. The path counter instructions can be inserted at an end of the loop after a last branch and prior to an exit point of a loop. In this manner, a respective path counter is incremented through each loop iteration based on the execution path through the loop. Once execution of the loop has completed (e.g., after a plurality of loop iterations), the registers will contain values indicative of the number of times a particular path through the loop has been taken for each possible execution path.

The one or more inserted instructions include inserting loop path counter array update instructions after the exit point of a loop. The loop path counter array update instructions update loop path counter entries in a loop path counter array with the number of executions for the paths taken through a respective loop associated with the executable program. The loop path counter array update instructions can be embedded in a multi-thread safe set of ownership instructions, such as a spinlock operation. The loop path counter array maintains a count associated with total path executions of each possible execution path over one or more loop executions associated with a given loop.

At 180, the modified instrumented executable function is encoded into a binary executable, and stored in shared memory. At 190, the break in the executable program associated with the given function is replaced with a branch/jump to the instrumented function and control is returned to the executable program. The methodology then proceeds to 200 where execution is continued at the start of the instrumented function. The methodology then returns to 110 until the next breakpoint is encountered.

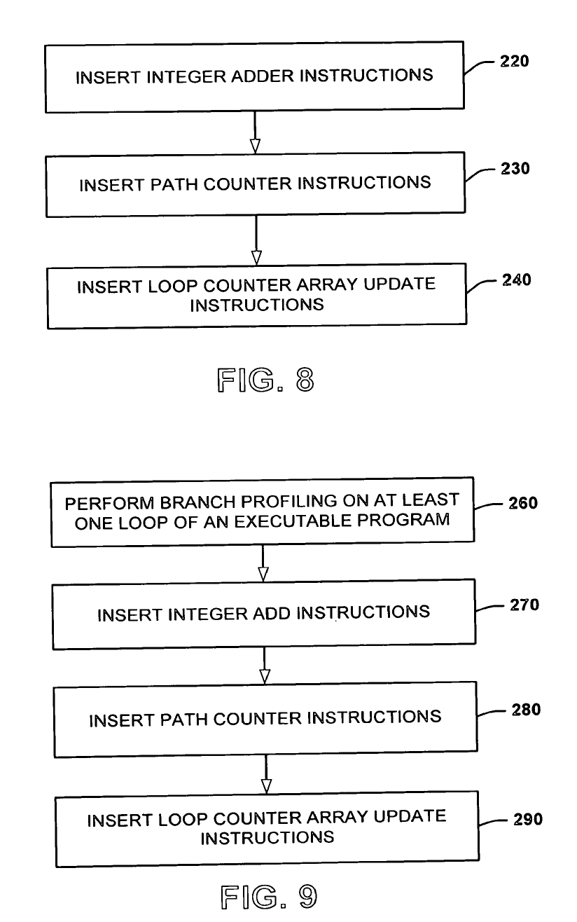

FIG. 8 illustrates an alternate methodology for branch profiling a loop associated with an executable program. At 220, integer add instructions are inserted in branches of a loop in an executable program. At 230, path counter instructions are inserted after a last branch of the loop and prior to an exit point of the loop. At 240, loop counter array update instructions are inserted after an exit point of the loop.

FIG. 9 illustrates yet another alternate methodology for branch profiling of an executable program. At 260, branch profiling is performed on at least one loop of an executable program to assign branch integers to branches and path values to execution paths in the at least one loop. At 270, integer add instructions are inserted in branches of the at least one loop. At 280, path counter instructions are inserted at an end of the at least one loop. At 290, loop path counter array update instructions are inserted after an exit point of the at least one loop.

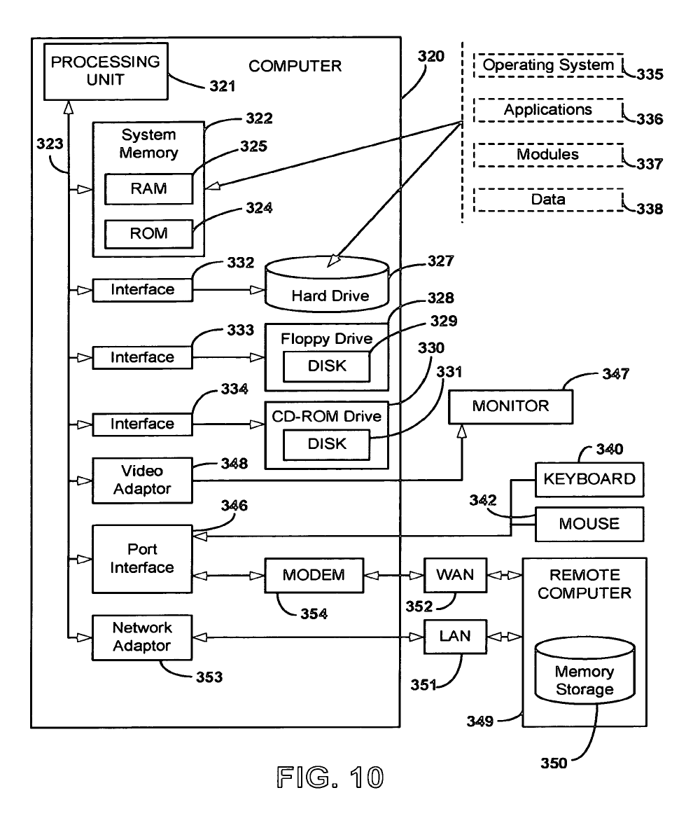

FIG. 10 illustrates a computer system 320 that can be employed to execute one or more embodiments employing computer executable instructions. The computer system 320 can be implemented on one or more general purpose networked computer systems, embedded computer systems, routers, switches, server devices, client devices, various intermediate devices/nodes and/or stand alone computer systems.

The computer system 320 includes a processing unit 321, a system memory 322, and a system bus 323 that couples various system components including the system memory to the processing unit 321. Dual microprocessors and other multi-processor architectures also can be used as the processing unit 321. The system bus may be any of several types of bus structure including a memory bus or memory controller, a peripheral bus, and a local bus using any of a variety of bus architectures. The system memory includes read only memory (ROM) 324 and random access memory (RAM) 325. A basic input/output system (BIOS) can reside in memory containing the basic routines that help to transfer information between elements within the computer system 320.

The computer system 320 can includes a hard disk drive 327, a magnetic disk drive 328, e.g., to read from or write to a removable disk 329, and an optical disk drive 330, e.g., for reading a CD-ROM disk 331 or to read from or write to other optical media. The hard disk drive 327, magnetic disk drive 328, and optical disk drive 330 are connected to the system bus 323 by a hard disk drive interface 332, a magnetic disk drive interface 333, and an optical drive interface 334, respectively. The drives and their associated computer-readable media provide nonvolatile storage of data, data structures, and computer-executable instructions for the computer system 320. Although the description of computer-readable media above refers to a hard disk, a removable magnetic disk and a CD, other types of media which are readable by a computer, such as magnetic cassettes, flash memory cards, digital video disks and the like, may also be used in the operating environment, and further that any such media may contain computer-executable instructions.

A number of program modules may be stored in the drives and RAM 325, including an operating system 335, one or more executable programs 336, other program modules 337, and program data 338. A user may enter commands and information into the computer system 320 through a keyboard 340 and a pointing device, such as a mouse 342. Other input devices (not shown) may include a microphone, a joystick, a game pad, a scanner, or the like. These and other input devices are often connected to the processing unit 321 through a corresponding port interface 346 that is coupled to the system bus, but may be connected by other interfaces, such as a parallel port, a serial port or a universal serial bus (USB). A monitor 347 or other type of display device is also connected to the system bus 323 via an interface, such as a video adapter 348.

The computer system 320 may operate in a networked environment using logical connections to one or more remote computers, such as a remote client computer 349. The remote computer 349 may be a workstation, a computer system, a router, a peer device or other common network node, and typically includes many or all of the elements described relative to the computer system 320. The logical connections can include a local area network (LAN) 351 and a wide area network (WAN) 352.

When used in a LAN networking environment, the computer system 320 can be connected to the local network 351 through a network interface or adapter 353. When used in a WAN networking environment, the computer system 320 can include a modem 354, or can be connected to a communications server on the LAN. The modem 354, which may be internal or external, is connected to the system bus 323 via the port interface 346. In a networked environment, program modules depicted relative to the computer system 320, or portions thereof, may be stored in the remote memory storage device 350.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A system for branch profiling an executable program, the system comprising:
a branch profiler that assigns branch integers to branches in a loop and a plurality of path values that correspond to sums of the branch integers through respective execution paths in the loop; and
a probe instrument that inserts an integer add instruction into branches of the loop, a set of path counter instructions after a last branch in the loop, and a set of loop path counter array update instructions after an exit point of the loop.

2. The system of claim 1, wherein the integer add instructions adds assigned branch integers of executed branches to provide a path value associated with an executed path through the loop for a single loop iteration, the set of path counter instructions increment path counters corresponding to executed paths over a plurality of loop iterations, and the set of loop path counter array update instructions update a loop path counter array that retains a count associated with executed paths over a plurality of loop executions.

3. The system of claim 1, further comprising a shared memory that retains the loop path counter array wherein the loop path counter array includes a plurality of loop path counter entries corresponding to different execution paths through the loop.

4. The system of claim 3, wherein the set of loop path counter array update instructions is embedded in a set of loop path counter array ownership instructions that facilitate multi-threaded safe loop path counter array integrity.

5. The system of claim 4, wherein the shared memory retains a loop path counter array access flag associated with the loop path counter array, the set of loop path counter array ownership instructions comprising at least a first instruction for requesting access to the loop path counter array and setting the loop path counter array access flag prior to updating the loop path counter array, and at least a second instruction for resetting the loop path counter array access flag after updating the loop path counter array, such that access of the loop path counter array is controlled based on the state of the loop path counter array access flag.

6. The system of claim 1, wherein the integer add instruction adds branch integers to a free register of the system.

7. The system of claim 1, wherein the set of path counter instructions comprise incrementing path counter registers assigned to respective execution paths.

8. The system of claim 1, wherein the set of path counter instructions comprise comparing a value of an integer adder associated with the integer add instructions with the plurality of path values and incrementing a corresponding path counter assigned to a respective execution path for each of a plurality of loop iterations.

9. The system of claim 1, wherein the probe instrument inserts an initialization instruction after a loop entry point to reset an integer adder and inserts initialization instructions prior to the loop entry point to reset the set of path counters.

10. The system of claim 1, wherein the loop path counter array update instructions update a plurality of loop path counter entries in a loop path counter array by adding the corresponding value of an associated path counter to its associated loop path counter entry.

11. The system of claim 10, wherein the loop path counter array update instructions update loop path counter entries with associated path counters that have a non-zero value.

12. The system of claim 1, wherein the loop is at least one of an innermost loop, an intermediary loop and an outermost loop of the executable program.

13. A method of branch profiling of an executable program, the method comprising:
inserting an integer add instruction in branches of a loop of the executable program;
inserting path counter instructions after a last branch of the loop and prior to an exit point of the loop; and
inserting loop counter array update instructions after the exit point of the loop.

14. The method of claim 13, further comprising finding a first free register to employ as an integer adder, and a set free registers to be employed as path counters for respective execution paths through the loop.

15. The method of claim 14, further comprising inserting initialization instruction to reset the path counters prior to an entry point of the loop, and inserting initialization instructions to reset the integer adder after the entry point of the loop.

16. The method of claim 13, further comprising repeating the inserting an integer adder instruction, inserting path counter instructions, and inserting loop counter array update instructions for a plurality of loops in a function of the executable program.

17. The method of claim 13, further comprising inserting the loop counter array update instructions between a loop path counter array ownership request instruction and a loop path counter array ownership release instruction, wherein a loop path counter array access flag is set when ownership of the loop path counter array is provided and reset when ownership of the loop path counter array is released.

18. The method of claim 13, wherein the inserting an integer add instruction, inserting path counter instructions, and inserting loop counter array update instructions is performed dynamically for a given function of the executable program as functions are executed.

19. A computer readable medium having computer executable instruction for performing a method comprising:
performing a branch profiling on at least one loop in an executable program to assign branch integers to branches and path values to execution paths in the at least one loop;
inserting integer add instructions to branches of the at least one loop;
inserting path counter instructions at an end of the at least one loop; and
inserting loop path counter array update instructions after an exit point of the at least one loop.

20. The computer readable medium having computer executable instruction for performing the method claim 19, further comprising performing loop analysis on an executable program to identify the at least one loop.

21. The computer readable medium having computer executable instruction for performing the method claim 20, wherein the performing a loop analysis on an executable program comprises:
representing a function of the executable program as an intermediate representation;
constructing a control flow graph from the intermediate representation; and
performing a loop recognition algorithm on the control flow graph to identify at least one loop in the function.

22. The computer readable medium having computer executable instruction for performing the method claim 19, wherein execution of the integer add instructions add a respective assigned branch integer of an executed branch to an integer add register, and execution of the path counter instructions increment a respective assigned path counter register based on a value of the integer add register after completion of an execution path of the at least one loop.

23. The computer readable medium having computer executable instruction for performing the method claim 22, wherein execution of the loop path counter array update instruction updates loop path counter entries associated with a loop path counter array with the values of at least one loop respective path counter register.

24. The computer readable medium having computer executable instruction for performing the method claim 22, further comprising inserting integer add register initialization instruction after a loop entry point of the at least one loop, and path counter register initialization instructions prior to a loop entry point.

25. The computer readable medium having computer executable instruction for performing the method claim 19, further comprising encoding the inserted instructions along with the at least one loop for an associated function to generate an instrumented function, and storing the instrumented function in memory.

26. A dynamic instrumentation system comprising:
means for generating an intermediate representation of a function associated with an executable program;
means for analyzing the intermediate representation to identify at least one loop in the function;
means for performing branch profiling on the identified at least one loop to assign branch integers to branches and path values to execution paths of the identified at least one loop;
means for inserting code into the identified at least one loop, the means for inserting code inserting integer add instructions into branches of the identified at least one loop, and path counter instructions at an end of the identified at least one loop; and
means for encoding the inserted code and the intermediate representation of the function to produce an instrumented function.

27. The system of claim 26, wherein the means for inserting code further comprising inserting loop path counter array update instructions after an exit point of the identified at least one loop.

28. The system of claim 27, further comprising means for storing a loop path counter array associated with execution of the loop path counter array update instructions.

29. The system of claim 27, wherein the means for inserting code into the identified at least one loop comprising embedding the loop path counter array update instructions between loop path counter array ownership instructions that facilitate multi-threaded safe loop path counter array integrity.

30. The system of claim 26, wherein the means for inserting code into the identified at least one loop comprising inserting an integer add register initialization instruction after a loop entry point of the identified at least one loop, and path counter register initialization instructions prior to the loop entry point of the identified at least one loop.
